(19) United States
(12) Patent Application Publication
(10) Pub. No.: US 2005/0088220 A1
(43) Pub. Date: Apr. 28, 2005

(54) Charge pump circuit having high charge transfer efficiency

(76) Inventors: Wook-ghee Hahn, Gyeonggi-do (KR); Dae-Seok Byeon, Gyeonggi-do (KR)

Correspondence Address: MARGER JOHNSON & MCCOLLOM, P.C., 1030 SW MORRISON STREET, PORTLAND, OR, 97205, US

(21) Appl. No.: 10/925,781

(22) Filed: Aug. 24, 2004

(30) Foreign Application Priority Data
Oct. 27, 2003 (KR) 2003-75225

(51) Int. Cl. G05F 3/02

(52) U.S. Cl. 327/536

(57) ABSTRACT

A charge pump circuit alleviates the body effect of a charge transfer transistor, thereby improving the charge transfer efficiency of the charge transfer transistor and thus pumping efficiency. The charge pump circuit includes a plurality of boosting stages that have input nodes and boosting nodes that are connected in series. Each of the boosting stages includes a charge transfer transistor and a first switch transistor, their respective gates being connected together. A first terminal of the charge transfer transistor is connected to one of the input nodes, and a second terminal of the charge transfer transistor is connected to one of the boosting nodes. The first switch transistor makes the voltage level at the bulk of the charge transfer transistors equal to the voltage level at the first terminal of the charge transfer transistor while charges are being transferred through the charge transfer transistor.

### CROSS REFERENCE TO RELATED APPLICATION

This application claims the priority of Korean Patent Application No. 2003-75225, filed on Oct. 27, 2003, in the Korean Intellectual Property Office, the disclosure of which is hereby incorporated by reference in its entirety.

### BACKGROUND OF THE INVENTION

1. Field of the Invention

The present invention relates to a semiconductor integrated circuit, and more particularly, to a charge pump circuit.

2. Description of the Related Art

In general, non-volatile memory devices that are erasable and programmable perform erase and programming operations on memory cells by using fowler-nordheim (F-N) tunneling or channel hot electron injection. To this end, a high voltage that is higher than a power supply voltage provided from the outside is required. The high voltage may be provided through an external pin or generated and used in a chip. To generate such a high voltage within a chip, a high voltage generating circuit is required and such a high voltage generating circuit is referred to as a charge pump circuit.

Recent reductions in the power supply voltage provided to chips make it difficult to generate a high voltage within the chips. As a result, there is a need for a charge pump circuit that operates efficiently.

FIG. 1 is a circuit diagram of a conventional charge pump circuit. Referring to FIG. 1, the conventional charge pump circuit includes a charge supply unit 10 and a plurality of boosting stages 20, 30, 40, and 50 that are connected in series.

The plurality of boosting stages 20, 30, 40, and 50 include charge transfer transistors P21, P31, P41, and P51, first switch transistors P22, P32, P42, and P52, second switch transistors P23, P33, P43, and P53, third switch transistors P24, P34, P44, and P54, first capacitors C21, C31, C41, and C51, second capacitors C22, C32, C42, and C52, third capacitors C23, C33, C43, and C53, first diodes D21, D31, D41, and D51, and second diodes D22, D32, D42, and D52, respectively.

The charge transfer transistors P21, P31, P41, and P51 transfer charges of input nodes I2, I3, I4, and I5, i.e., charges boosted by a previous boosting stage, to boosting nodes O2, O3, O4, and O5. The first switch transistors P22, P32, P42, and P52 and the second switch transistors P23, P33, P43, and P53 are intended to maintain voltages at bulks B2, B3, B4, and B5 of the charge transfer transistors P21, P31, P41, and P51 at the higher of the voltages at the input nodes I2, I3, I4, and I5 and the voltages at the boosting nodes O2, O3, O4, and O5.

The third switch transistors P24, P34, P44, and P54, the first capacitors C21, C31, C41, and C51, the second capacitors C22, C32, C42, and C52, the third capacitors C23, C33, C43, and C53, the first diodes D21, D31, D41, and D51, and the second diodes D22, D32, D42, and D52 perform charge boosting. A signal PUMPEN enables a charge supply unit 10 while signals PS1 and PS2 control boosting. The final boosted voltage is denoted as VPP.

When the charges at the input nodes I2, I3, I4, and I5, i.e., the charges boosted by the previous boosting stage, are transferred to a next boosting stage through the charge transfer transistors P21, P31, P41, and P51, the charge transfer transistors P21, P31, P41, and P51 should not limit the transfer of charge. In other words, the charge transfer efficiency of the charge transfer transistors P21, P31, P41, and P51 should be high.

However, in a conventional charge pump circuit, while charges are being transferred through the charge transfer transistors P21, P31, P41, and P51, the voltage levels at the boosting nodes O2, O3, O4, and O5 connected to the gates of the first transistors P22, P32, P42, and P52 increase. As a result, the first switch transistors P22, P32, P42, and P52 are turned off, the voltages at the bulks B2, B3, B4, and B5 of the charge transfer transistors P21, P31, P41, and P51 fail to be discharged, and the highest voltages at the input nodes I2, I3, I4, and I5 are maintained.

Thus, the charge transfer transistors P21, P31, P41, and P51 are affected by the body effect. Subsequently, the threshold voltages of the charge transfer transistors P21, P31, P41, and P51 increase and the charge transfer efficiency of the charge transfer transistors P21, P31, P41, and P51 decreases. Such a phenomenon degrades the pumping efficiency of the charge pump circuit.

### SUMMARY OF THE INVENTION

The present invention provides a charge pump circuit that improves the charge transfer efficiency of a charge transfer transistor by alleviating the body effect of the charge transfer transistor, thus improving pumping efficiency.

According to an aspect of the present invention, there is provided a charge pump circuit comprising a plurality of boosting stages, which have input nodes and boosting nodes and are connected in series, wherein each of the boosting stages comprises: a charge transfer transistor comprising a first terminal connected to one of the input nodes and a second terminal connected to one of the boosting nodes; and a first switch transistor, which makes a voltage level at a bulk of the charge transfer transistor equal to a voltage level at the first terminal of the charge transfer transistor while charges are being transferred through the charge transfer transistor, wherein a gate of the first switch transistor is connected to a gate of the charge transfer transistor.

Each of the boosting stages may further comprise a second switch transistor that makes the voltage level at the bulk of the charge transfer transistor equal to a voltage level at the second terminal of the charge transfer transistor, and a gate of the second switch transistor may be connected to the first terminal of the charge transfer transistor.

According to another aspect of the present invention, there is provided a charge pump circuit comprising a plurality of boosting stages, which have input nodes and boosting nodes and are connected in series, wherein each of the boosting stages comprises: a charge transfer transistor comprising a first terminal connected to one of the input nodes and a second terminal connected to one of the boosting nodes; a first switch transistor, one terminal of which is connected to the first terminal of the charge transfer transistor, the other terminal of which is connected to a bulk of the charge transfer transistor, and a gate of which is connected to a gate of the charge transfer transistor; and a second switch transistor, one terminal of which is connected to the second terminal of the charge transfer transistor, the other terminal of which is connected to the bulk of the charge transfer transistor, and a gate of which is connected to the first terminal of the charge transfer transistor.

### BRIEF DESCRIPTION OF THE DRAWINGS

The above and other aspects and advantages of the present invention will become more apparent by describing in detail an exemplary embodiment thereof with reference to the attached drawings in which:

FIG. 1 is a circuit diagram of a conventional charge pump circuit;

FIG. 2 is a circuit diagram of a charge pump circuit according to an embodiment of the present invention;

FIG. 3A shows a simulation result of the conventional charge pump circuit of FIG. 1; and

FIG. 3B shows a simulation result of the charge pump circuit of FIG. 2.

### DETAILED DESCRIPTION OF THE INVENTION

The present invention will now be described more fully with reference to the accompanying drawings, in which an embodiment of the invention is shown. Throughout the drawings, like reference numerals are used to refer to like elements.

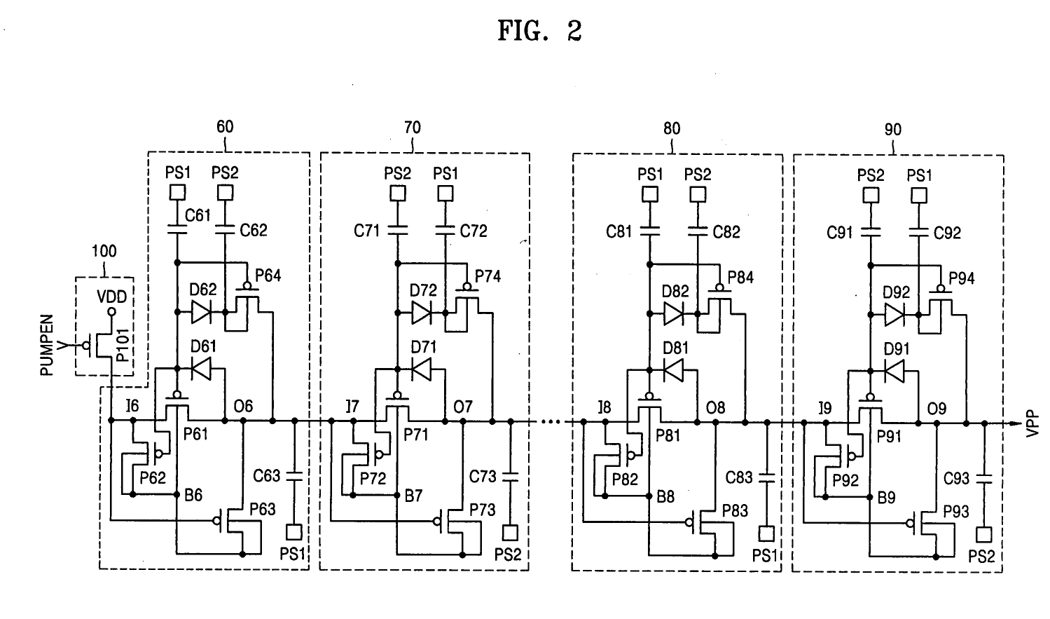

FIG. 2 is a circuit diagram of a charge pump circuit according to an embodiment of the present invention.

Referring to FIG. 2, the charge pump circuit includes a charge supply unit 100 and a plurality of boosting stages 60, 70, 80, and 90 that are connected in series.

The charge supply unit 100 supplies charges to an input node I6 of the first boosting stage 60 among the plurality of boosting stages 60, 70, 80, and 90 in response to an enable signal PUMPEN. The charge supply unit 100 includes a PMOS transistor P101. A power supply voltage VDD is provided to the source of the PMOS transistor P101, an enable signal PUMPEN is provided to the gate of the PMOS transistor P101, and the drain of the PMOS transistor P101 is connected to the input node I6 of the first boosting stage 60.

The boosting stages 60, 70, 80, and 90 include charge transfer transistors P61, P71, P81, and P91, first switch transistors P62, P72, P82, and P92, second switch transistors P63, P73, P83, and P93, third switch transistors P64, P74, P84, and P94, first capacitors C61, C71, C81, and C91, second capacitors C62, C72, C82, and C92, third capacitors C63, C73, C83, and C93, first diodes D61, D71, D81, and D91, and second diodes D62, D72, D82, and D92, respectively.

The charge transfer transistors P61, P71, P81, and P91 transfer charges at input nodes I6, I7, I8, and I9, i.e., charges boosted by a previous boosting stage, to boosting nodes O6, O7, O8, and O9. The charge transfer transistors P61, P71, P81, and P91 are realized as PMOS transistors. In each PMOS transistor, one terminal, i.e., one of a source and a drain, is connected to one of the input nodes I6, I7, I8, and I9 and the other terminal, i.e., the other one of the source and the drain, is connected to one of the boosting nodes O6, O7, O8, and O9. The charge transfer transistors P61, P71, P81, and P91 are formed in floated n-type wells that are formed in a semiconductor substrate.

The first switch transistors P62, P72, P82, and P92 make the voltage levels at the bulks B6, B7, B8, and B9 of the charge transfer transistors P61, P71, P81, and P91 equal to the voltage levels at the input nodes I6, I7, I8, and I9, while charges are being transferred through the charge transfer transistors P61, P71, P81, and P91. The second switch transistors P63, P73, P83, and P92 make the voltage levels at the bulks B6, B7, B8, and B9 of the charge transfer transistors P61, P71, P81, and P91 equal to the voltage levels at the boosting nodes O6, O7, O8, and O9.

The terminals of the first switch transistors P62, P72, P82, and P92 are connected to the terminals of the charge transfer transistors P61, P71, P81, and P91, i.e., the input nodes I6, I7, I8, and I9, respectively. The other terminals of the first switch transistors P62, P72, P82, and P92 are connected to the bulks B6, B7, B8, and B9 of the charge transfer transistors P61, P71, P81, and P91, respectively. In particular, the gates of the first switch transistors P62, P72, P82, and P92 are connected to the gates of the charge transfer transistors P61, P71, P81, and P91, respectively. The terminals of the second switch transistors P63, P73, P83, and P93 are connected to the other terminals of the charge transfer transistors P61, P71, P81, and P91, i.e., the boosting nodes O6, O7, O8, and O9, respectively. The other terminals of the second switch transistors P63, P73, P83, and P93 are connected to the bulks B6, B7, B8, and B9 of the charge transfer transistors P61, P71, P81, and P91, respectively. The gates of the second switch transistors P63, P73, P83, and P93 are connected to the terminals of the charge transfer transistors P61, P71, P81, and P91, i.e., the input nodes I6, I7, I8, and I9, respectively.

The third switch transistors P64, P74, P84, and P94, the first capacitors C61, C71, C81, and C91, the second capacitors C62, C72, C82, and C92, the third capacitors C63, C73, C83, and C93, the first diodes D61, D71, D81, and D91, and the second diodes D62, D72, D82, and D92 perform charge boosting. Control signals PS1 and PS2 control boosting and are 180° out of phase with each other.

The terminals of the third switch transistors P64, P74, P84, and P94 are connected to the negative terminals of the second diodes D62, D72, D82, and D92, respectively. The other terminals of the third switch transistors P64, P74, P84, and P94 are connected to the boosting nodes O6, O7, O8, and O9, respectively. The gates of the third switch transistors P64, P74, P84, and P94 are connected to the gates of the charge transfer transistors P61, P71, P81, and P91, respectively.

The terminals of the first capacitors C61, C71, C81, and C91 are connected to the control signals PS1, PS2, PS1, and PS2, respectively. The other terminals of the first capacitors C61, C71, C81, and C91 are connected to the gates of the charge transfer transistors P61, P71, P81, and P91, respectively. The terminals of the second capacitors C62, C72, C82, and C92 are connected to the control signals PS2, PS1, PS2, and PS1, respectively. The other terminals of the second capacitors C62, C72, C82, and C92 are connected to the negative terminals of the second diodes D62, D72, D82, and D92, respectively. The terminals of the third capacitors C63, C73, C83, and C93 are connected to the boosting nodes O6, O7, O8, and O9, respectively. The other terminals of the third capacitors C63, C73, C83, and C93 are connected to the control signals PS1, PS2, PS1, and PS2, respectively.

The positive terminals of the first diodes D61, D71, D81, and D91 are connected to the boosting nodes O6, O7, O8, and O9, respectively. The negative terminals of the first diodes D61, D71, D81, and D91 are connected to the gates of the charge transfer transistors P61, P71, P81, and P91, respectively. The positive terminals of the second diodes D62, D72, D82, and D92 are also connected to the gates of the charge transfer transistors P61, P71, P81, and P91, respectively. Here, the first switch transistors, P62, P72, P82, and P92, the second switch transistors P63, P73, P83, and P93, and the third switch transistors P64, P74, P84, and P94 are PMOS transistors.

As described above, in the charge pump circuit according to the present invention, the gates of the first switch transistors P62, P72, P82, and P92 are connected to the gates of the charge transfer transistors P61, P71, P81, and P91, respectively, and the gates of the charge transfer transistors P61, P71, P81, and P91 are connected to the control signals PS1, PS2, PS1, and PS2 via the first capacitors C61, C71, C81, and C91.

While the charges are transferred through the charge transfer transistors P61, P71, P81, and P91, i.e., the control signals PS1, PS2, PS1, and PS2 are at a low level, the first switch transistors P62, P72, P82, and P92 remain in a turn-on state. As a result, the voltage levels at the bulks B6, B7, B8, and B9 of the charge transfer transistors P61, P71, P81, and P91 are nearly the same as those at the input nodes I6, I7, I8, and I9. In other words, the voltage levels at the bulks B6, B7, B8, and B9 that are high at an early stage of charge transfer decrease as the voltage levels at the input nodes I6, I7, I8, and I9 decrease due to charge transfer.

Consequently, the body effect of the charge transfer transistors P61, P71, P81, and P91 is alleviated and the threshold voltages of the charge transfer transistors P61, P71, P81, and P91 do not increase. As a result, the charge transfer efficiency of the charge transfer transistors P61, P71, P81, and P91 is improved and the pumping efficiency of the charge pump circuit is also improved.

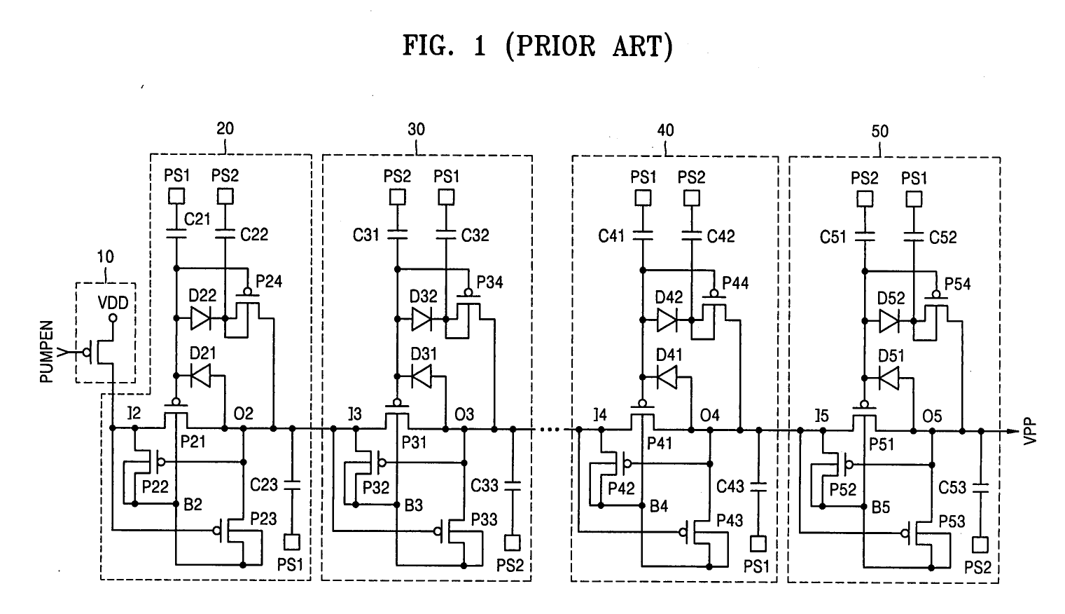

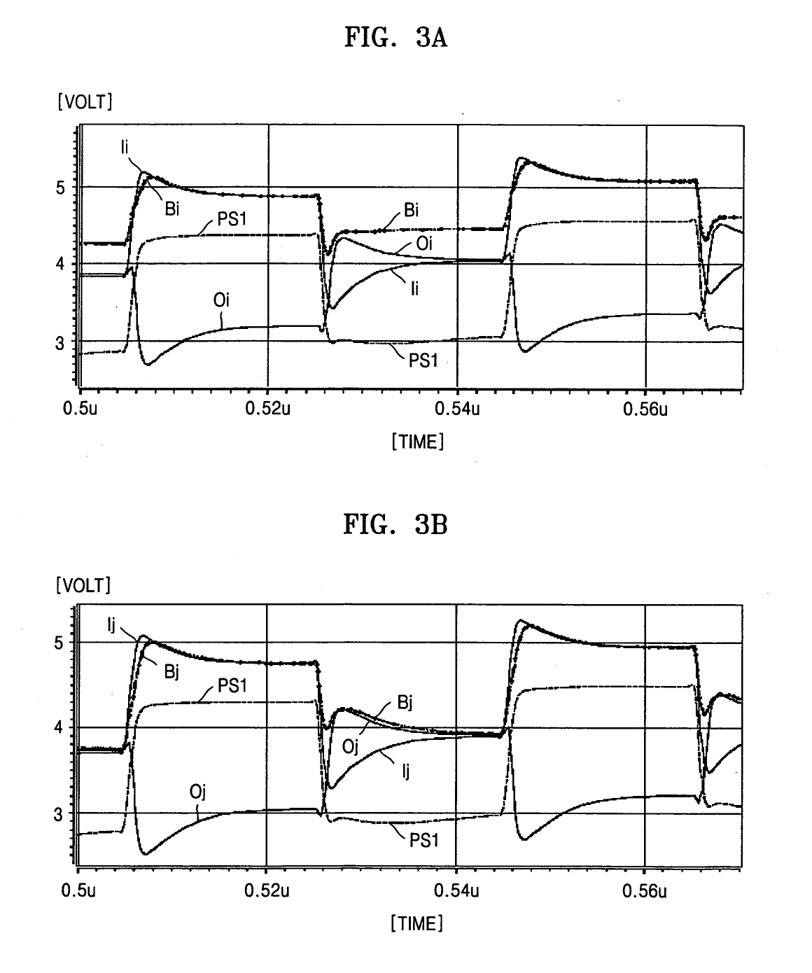

FIG. 3A shows a simulation result of the conventional charge pump circuit of FIG. 1, and FIG. 3B shows a simulation result of the charge pump circuit of FIG. 2.

In FIG. 3A, Ii, Oi, and Bi represent voltages at the input node, the boosting node, and the bulk of one of the charge transfer transistors P21, P31, P41, and P51 in the conventional charge pump circuit of FIG. 1. In FIG. 3B, Ij, Oj, and Bj represent voltages at the input node, the boosting node, and the bulk of one of the charge transfer transistors P61, P71, P81, and P91 in the charge pump circuit of FIG. 2. PS1 represents a control signal provided to the charge transfer transistors P21, P31, P41, and P51 and P61, P71, P81, and P91.

As can be seen from FIG. 3A, in the conventional charge pump circuit, while charges are being transferred through the charge transfer transistors P21, P31, P41, and P51, i.e., when the control signal PS1 is at a low level for P21 and P41, and PS2 is at a low level for P31 and P51, the voltage Bi at the bulks of the charge transfer transistors P21, P31, P41, and P51 fails to be discharged and is maintained at the highest voltage Ii at the input node. In contrast, it can be seen from FIG. 3B that, in the charge pump circuit according to the present invention, while the control signal PS1 is at a low level, the voltage Bj at the bulks of the charge transfer transistors P61, P71, P81, and P91 decrease from a high voltage level at the early stage of charge transfer nearly to the voltage Ij at the input node.

Hereinafter, the operation of the charge pump circuit according to the present invention will be described in detail. When the enable signal PUMPEN is transited to a low level and the control signals PS1 and PS2 start mutually exclusive pulse operations, the input node I6 of the first boosting stage 60 is connected to the power supply voltage VDD and the boosting stages 60, 70, 80, and 90 start charge pumping. At this time, if the control signal PS1 is at a low level and the control signal PS2 is at a high level, the voltage at the gate of the charge transfer transistor P61 goes lower than the voltage at the source of the charge transfer transistor P61, i.e., the input node I6, by an amount equal to or greater than the threshold voltage of the charge transfer transistor P61. Thus, the charge transfer transistor P61 is turned on and charges flowing from the power supply voltage VDD are transferred to the boosting node O6.

After that, once the control signal PS1 goes high and the control signal PS2 goes low, the voltage at the gate of the charge transfer transistor P71 goes lower than the voltage at the input node I7 by an amount equal to or greater than the threshold voltage of the charge transfer transistor P71 and the charge transfer transistor P71 is turned on. As a result, charges at the boosting node O6, i.e., the input node I7, are transferred to the boosting node O7. At this time, the voltage at the gate of the charge transfer transistor P61 increases due to charge transfer from the boosting node O6 to the gate of the charge transfer transistor P61 via a diode D61. Consequently, the charges at the boosting node O6 do not flow back to the input node I6.

The operations described above are performed consecutively at boosting stages that are serially connected and charges are transferred to the last boosting stage 90 from the power supply voltage VDD. Some charges are used to increase the voltages at the boosting nodes O6, O7, O8, and O9. The charge transferred to the last boosting stage 90 is transferred to a voltage VPP when the control signal PS1 goes low. Through this procedure, the voltages at the boosting nodes O6, O7, O8, and O9 and the voltage VPP gradually increase.

As described above, the charge pump circuit according to the present invention alleviates body effect of charge transfer transistor, thereby improving the charge transfer efficiency of the charge transfer transistor and its pumping efficiency.

While the present invention has been particularly shown and described with reference to an exemplary embodiment thereof, it will be understood by those of ordinary skill in the art that various changes in form and details may be made therein without departing from the spirit and scope of the invention as defined by the appended claims and their equivalents.

1. A charge pump circuit comprising a plurality of boosting stages, which have input nodes and boosting nodes and are connected in series,
wherein each of the boosting stages comprises:
a charge transfer transistor comprising a first terminal connected to one of the input nodes and a second terminal connected to one of the boosting nodes; and
a first switch transistor, which makes a voltage level at a bulk of the charge transfer transistor equal to a voltage level at the first terminal of the charge transfer transistor while charges are being transferred through the charge transfer transistor,
wherein a gate of the first switch transistor is connected to a gate of the charge transfer transistor.

2. The charge pump circuit of claim 1, further comprising a charge supply unit to supply charge, in response to an enable signal, to an input node of a first boosting stage among the plurality of boosting stages that are connected in series.

3. The charge pump circuit of claim 1, wherein each of the boosting stages further comprises a second switch transistor to make the voltage level at the bulk of the charge transfer transistor equal to a voltage level at the second terminal of the charge transfer transistor, and a gate of the second switch transistor is connected to the first terminal of the charge transfer transistor.

4. The charge pump circuit of claim 3, wherein each of the boosting stages further comprises:
a first capacitor, having one terminal connected to one of a first control signal and a second control signal and having another terminal connected to the gate of the charge transfer transistor;
a second capacitor, having one terminal connected to the other one of the first control signal and the second control signal;
a third capacitor having one terminal connected to one of the boosting nodes and having another terminal connected to one of the first control signal and the second control signal;
a first diode having a positive terminal connected to one of the boosting nodes and having a negative terminal connected to the gate of the charge transfer transistor;
a second diode having a positive terminal connected to the gate of the charge transfer transistor and having a negative terminal connected to the other terminal of the second capacitor; and
a third switch transistor having one terminal connected to the negative terminal of the second diode, and having another terminal connected to the boosting node, and having a gate connected to the gate of the charge transfer transistor.

5. The charge pump circuit of claim 4, wherein the charge transfer transistor and the first through third switch transistors are PMOS transistors.

6. A charge pump circuit comprising a plurality of boosting stages having input nodes and boosting nodes and are connected in series, wherein each of the boosting stages comprises:
a charge transfer transistor comprising a first terminal connected to one of the input nodes and a second terminal connected to one of the boosting nodes;
a first switch transistor having one terminal connected to the first terminal of the charge transfer transistor, and another terminal connected to a bulk of the charge transfer transistor, and having a gate connected to a gate of the charge transfer transistor; and
a second switch transistor, having one terminal connected to the second terminal of the charge transfer transistor, having another terminal connected to the bulk of the charge transfer transistor, and having a gate of the second switch transistor connected to the first terminal of the charge transfer transistor.

7. The charge pump circuit of claim 6, further comprising a charge supply unit to supplies charge, in response to an enable signal, to an input node of a first boosting stage among the plurality of boosting stages that are connected in series.

8. The charge pump circuit of claim 6, wherein each of the boosting stages further comprises:
a first capacitor, having one terminal connected to one of a first control signal and a second control signal and having another terminal connected to the gate of the charge transfer transistor;
a second capacitor, having one terminal connected to the other one of the first control signal and the second control signal;
a third capacitor, having one terminal connected to one of the boosting nodes and having another terminal connected to one of the first control signal and the second control signal;
a first diode having a positive terminal connected to the one of the boosting nodes and having a negative terminal connected to the gate of the charge transfer transistor;
a second diode having a positive terminal connected to the gate of the charge transfer transistor and having a negative terminal connected to the other terminal of the second capacitor; and
a third switch transistor having one terminal connected to the negative terminal of the second diode, having a second terminal connected to the boosting node, and having a gate connected to the gate of the charge transfer transistor.

9. The charge pump circuit of claim 8, wherein the charge transfer transistor and the first through third switch transistors are PMOS transistors.
